(19) United States
(12) Patent Application Publication
(10) Pub. No.: US 2006/0123175 A1
(43) Pub. Date: Jun. 8, 2006

(54) Universal serial bus access device with selectable modes

(75) Inventors: Gordon Yu, Taipei (TW); Hung-Tse Ho, Taipei City (TW); Ying-Lung Liu, Taipei City (TW); Ching-Lung Wu, Baihe Township (TW)

Correspondence Address: BACON & THOMAS, PLLC, 625 SLATERS LANE, FOURTH FLOOR, ALEXANDRIA, VA, 22314, US

(73) Assignee: C-One Technology Corporation, Hsin-Chu City (TW)

(21) Appl. No.: 11/152,232

(22) Filed: Jun. 15, 2005

(30) Foreign Application Priority Data
Dec. 3, 2004 (TW) 093219535

(51) Int. Cl. G06F 13/14

(52) U.S. Cl. 710/305

(57) ABSTRACT

An USB access device with selectable modes is comprised of an USB interface unit for connecting to an electronic device; an USB controller connected to the USB interface unit; and a manual switch connected to the USB controller for switching the USB controller to either master or slave mode. When the manual switch switches the USB controller to operate in the master mode, the USB controller is set to execute a master-mode driver. When the manual switch switches the USB controller to operate in the slave mode, the USB controller is set to execute a slave-mode driver.

### BACKGROUND OF THE UTILITY

1. Field of the Invention

The present invention relates to a portable storage device and more particularly, to an universal serial bus (USB) access device with selectable modes.

2. Description of Related Art

With the advance of electronic technology, the size of portable electronic devices, for instances, digital cameras, MP3 players, PDA, etc., is becoming smaller and lighter while their ability of processing digital information has grown tremendously beyond imagination. General speaking, transferring or accessing data between portable devices and computers can be achieved via internet or diskettes; however, due to their limited capacity and lack of portability, diskettes have been gradually taken over by portable storage devices for data accessing, such as a flash disk. Such portable storage devices can process in data transfer by inserting directly into an electronic device.

Flash disks nowadays commonly utilize USB interface as their mean for transfer. Also, it is rather convenient to transfer image data from digital cameras to computers by simply turning on the cameras and connecting them together with USB cables. Further applications such as viewing, editing or printing images can be just as easy following the steps mentioned above. Until now the USB interface of flash disks or digital cameras is set as slave mode as their default configuration, and the ones of the electronic devices, such as personal computers, in contrast are set as master mode as default. Because these default configurations inevitably hinder the flexibility of utilizing USB interface, it is desired to provide an USB access device with selectable modes to increase its adaptability.

### BRIEF DESCRIPTION OF THE DRAWINGS

FIG. 1 is a schematic diagram illustrating the functional structure of the present invention of an USB access device with selectable modes.

FIG. 2 is a mode-setting flow chart of the USB access device with selectable modes.

### SUMMARY OF THE INVENTION

The present invention has been accomplished under the circumstances in view. It is therefore the main object of the present invention to provide an USB access device with selectable modes wherein the master and slave mode could be switched from one to another.

To achieve this and other objects of the present invention, the USB access device with selectable modes comprising in accordance with the present invention includes: an USB interface unit adapted for connecting to an electronic device; an USB controller connected to a functional module and further connected to the USB interface unit; and a manual switch connected to the USB controller, for switching the USB controller to either master or slave mode, wherein when the manual switch switches the USB controller to operate in the master mode, the USB controller is set to execute a master-mode driver, and when the manual switch switches the USB controller to operate in the slave mode, the USB controller is set to execute a slave-mode driver.

### DETAILED DESCRIPTION OF THE PREFERRED EMBODIMENT

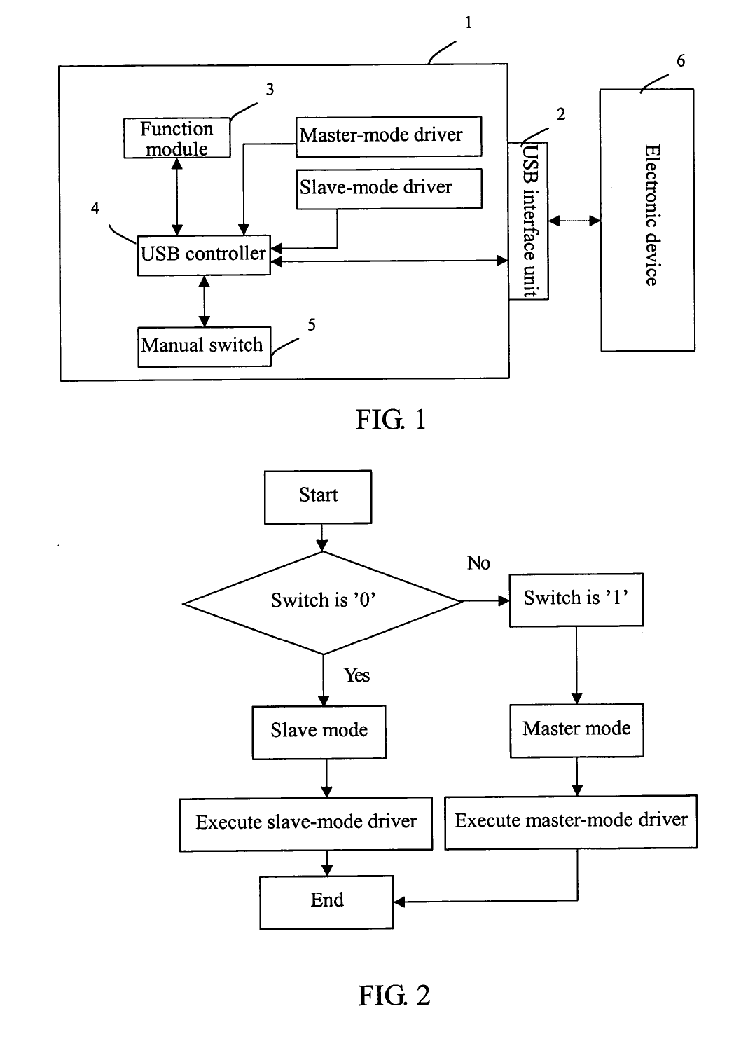

FIG. 1 is a schematic diagram that illustrates the preferred embodiment of the present invention of the USB access device with selectable modes, which includes an USB interface unit 2, a function module 3, an USB controller 4, and a manual switch 5. The function module 3 is preferably to be a flash memory.

The USB interface unit 2 is provided for connection to an electronic device 6, which can be a printer, a computer device, a cellular phone, or a digital camera, while the USB interface unit 2 can be an USB connector according to this embodiment. The USB controller 4 is connected to both the function module 3 and the USB interface unit 2 respectively; the manual switch 5 is connected to the USB controller 4 and thus can manually select the modes.

The manual switch 5 is designed to switch the USB controller 4 to operate either in master or in slave mode. When the manual switch 5 switches to master mode, the USB controller thereof 4 will then execute a master-mode driver; when the manual switch 5 switches to slave mode, the USB controller thereof 4 will then execute a slave-mode driver.

Also with reference to FIG. 2 illustrating a mode-switching flow chart, the configuration of the manual switch of the access device showing ‘0’ implies that the mode is set as slave while a slave-mode driver is executed; whereas the configuration of the manual switch of the access device showing ‘1’ implies that the mode is set as master while a master-mode driver is executed.

In view of the foregoing, it shall be known that the present invention utilizes a manual switch 5 to set the mode of USB interface to be in either master or slave. Under the master mode, the USB controller is set to execute a master-mode driver whereas under slave mode the USB controller is set to execute a master-mode driver, consequently enabling the USB access device to be set in either master or slave mode and as a result making the utilization of USB interface unconstrained.

Although the present invention has been explained in relation to its preferred embodiment, it is to be understood that many other possible modifications and variations can be made without departing from the spirit and scope of the invention as hereinafter claimed.

What is claimed is:

1. An USB access device with selectable modes comprising
an USB interface unit adapted for connecting to an electronic device;
an USB controller connected to a functional module and further connected to the USB interface unit; and
a manual switch connected to the USB controller, for switching the USB controller to either master or slave mode, wherein when the manual switch switches the USB controller to operate in the master mode, the USB controller is set to execute a master-mode driver, and when the manual switch switches the USB controller to operate in the slave mode, the USB controller is set to execute a slave-mode driver.

2. The USB access device with selectable modes as claimed in claim 1, wherein configurations set by the manual switch are either ‘0’ or ‘1’.

3. The USB access device with selectable modes as claimed in claim 2, as the configuration set by the manual switch is ‘0’, the mode is set as slave, and a slave-mode driver is executed.

4. The USB access device with selectable modes as claimed in claim 2, as the configuration set by the manual switch is ‘1’, the mode is set as master, and a master-mode driver is executed.

5. The USB access device with selectable modes as claimed in claim 1, wherein the functional module is a flash memory.

6. The USB access device with selectable modes as claimed in claim 1, wherein the functional module is a digital camera.

7. The USB access device with selectable modes as claimed in claim 1, wherein the functional module is a printer.

8. The USB access device with selectable modes as claimed in claim 1, wherein the functional module is a cellular phone.
